(19) United States
(12) Patent Application Publication
(10) Pub. No.: US 2026/0005805 A1
(43) Pub. Date: Jan. 1, 2026

(54) SINGULAR VALUE DECOMPOSITION COMBINER PRECODING

(71) Applicant: QUALCOMM Incorporated, San Diego, CA (US)

(72) Inventors: Aviv REGEV, Tel Aviv (IL); Ronen SHAKED, Kfar Saba (IL); Amit BAR-OR TILLINGER, Tel-Aviv (IL)

(21) Appl. No.: 18/758,593

(22) Filed: Jun. 28, 2024

(51) Int. Cl. H04L 5/00; H04B 7/0456; H04W 72/231; H04W 72/51; H04W 72/541

(52) U.S. Cl. CPC H04L 5/0023; H04B 7/046; H04W 72/231; H04W 72/51; H04W 72/541

(57) ABSTRACT

Certain aspects of the present disclosure provide techniques for singular value decomposition (SVD) combiner precoding. An example method performed by the UE includes receiving, from a network entity, a request for a downlink transmission preference of the UE, transmitting, to the network entity after receiving the request, a first message indicating the downlink transmission preference of the UE, wherein the downlink transmission preference of the UE comprises at least one of a demodulation complexity preference of the UE or a downlink channel capacity preference of the UE, receiving, from the network entity, a first downlink signal transmitted on a downlink channel using a plurality of transmission streams, wherein the first downlink signal is precoded based on a first precoder and the first precoder is based on the downlink transmission preference of the UE, and demodulating the first downlink signal using a first demodulator corresponding to the first precoder.

### BACKGROUND

### Field of the Disclosure

Aspects of the present disclosure relate to wireless communications, and more particularly, to techniques for singular value decomposition (SVD) combiner precoding.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communication by a network entity. The method includes transmitting, to a user equipment (UE), a request for a downlink transmission preference of the UE, receiving, from the UE after transmitting the request, a first message indicating the downlink transmission preference of the UE, wherein the downlink transmission preference of the UE comprises at least one of a demodulation complexity preference of the UE or a downlink channel capacity preference of the UE, applying a first precoder, selected based on the downlink transmission preference of the UE, to a first downlink signal for transmission to the UE, and transmitting the precoded first downlink signal to the UE over a downlink channel using a plurality of transmission streams.

Another aspect provides a method for wireless communication by a user equipment (UE). The method includes receiving, from a network entity, a request for a downlink transmission preference of the UE, transmitting, to the network entity after receiving the request, a first message indicating the downlink transmission preference of the UE, wherein the downlink transmission preference of the UE comprises at least one of a demodulation complexity preference of the UE or a downlink channel capacity preference of the UE, receiving, from the network entity, a first downlink signal transmitted on a downlink channel using a plurality of transmission streams, wherein the first downlink signal is precoded based on a first precoder and the first precoder is based on the downlink transmission preference of the UE, and demodulating the first downlink signal using a first demodulator corresponding to the first precoder.

Other aspects provide: an apparatus operable, configured, or otherwise adapted to perform any one or more of the aforementioned methods and/or those described elsewhere herein; a non-transitory, computer-readable media comprising instructions that, when executed by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5A includes a graph that plots signal to noise ratios (SNRs) of four different streams when a conventional singular value decomposition (SVD) precoder is used to precode data for transmission over a downlink channel.

FIG. 5B includes a graph that plots SNRs of the four different streams when an SVD combiner precoder is used to precode data for transmission over a downlink channel.

FIG. 6 depicts a process flow including operations for communications in a network between a network entity and a user equipment.

FIG. 7 depicts a method for wireless communications.

FIG. 8 depicts a method for wireless communications.

FIG. 9 depicts aspects of an example communications device.

FIG. 10 depicts aspects of an example communications device.

### DETAILED DESCRIPTION

Aspects of the present disclosure provide apparatuses, methods, processing systems, and computer-readable mediums for singular value decomposition (SVD) combiner precoding.

For example, improving spectral efficiency in a closed-loop OFDM-MIMO communication system often involves the use of a conventional singular value decomposition (SVD) precoder. This technique allows a wireless communication device to transmit data through the strongest spatial directions of a wireless channel, maximizing the signal-to-noise ratio (SNR). In addition to maximizing SNR in strong spatial directions, SVD precoding also simplifies the MIMO system to function like multiple parallel single-input single-output (SISO) links, thereby reducing demodulation complexity at a receiver device.

However, SVD precoding faces limitations due to a requirement that all streams or layers transmitted through the wireless channel use the same modulation and coding scheme (MCS). This becomes problematic as each stream ideally requires a different MCS to maximize its SNR gain. In a single MCS scenario, the stream with the weakest SNR dictates the overall MCS, which often necessitates lowering the MCS to ensure successful decoding of all streams. This downgrade reduces the overall data transmission throughput, negatively impacting user experience.

Accordingly, aspects of the present disclosure provide techniques for improving performance or throughput associated with transmitting data over the wireless channel. For example, in some cases, these techniques may involve using a SVD combiner precoder to precode a downlink signal for transmission to a receiver device, such as a user equipment. The SVD combiner precoder may be configured to combine the strongest singular Eigen vectors corresponding to singular values of the wireless channel equally among different streams in order to break the SNR difference between different streams. In other words, by using the SVD combiner precoder, the SNR of the “weakest” steam (e.g., the stream with the lowest SNR) may be improved such that all streams attain the same or similar SNR. That is, each stream will benefit from an SNR which is an average SNR (e.g., average across the streams) of a traditional SVD precoding scheme. Accordingly, by improving the SNR of the “weakest” stream, an MCS associated with a higher throughput may be used, thereby improving user experience and spectral efficiency.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

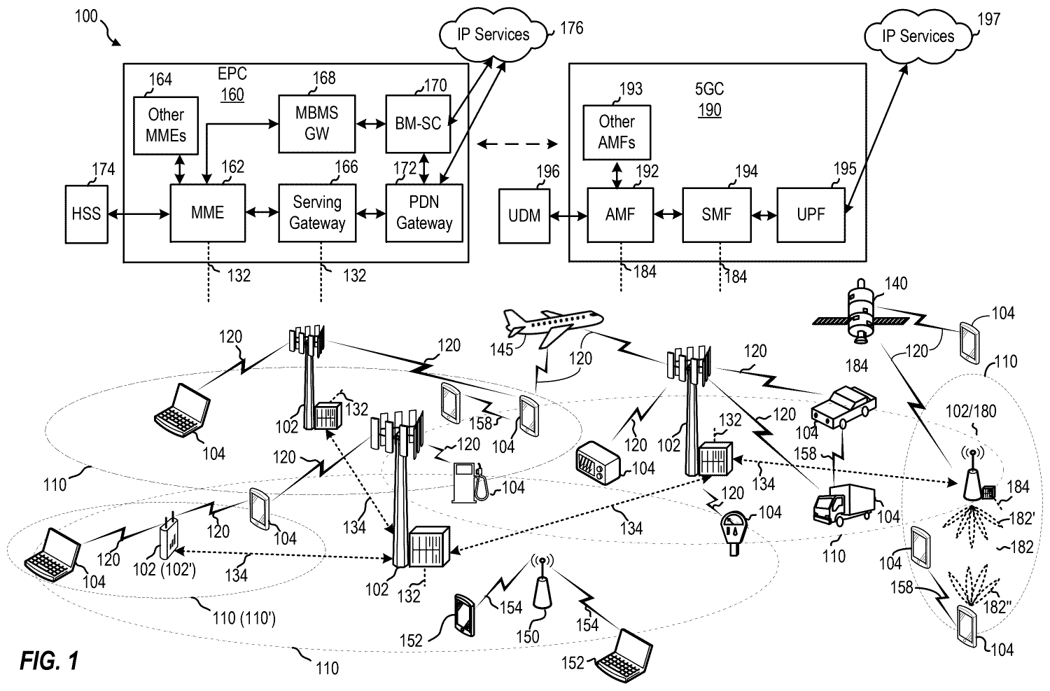

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

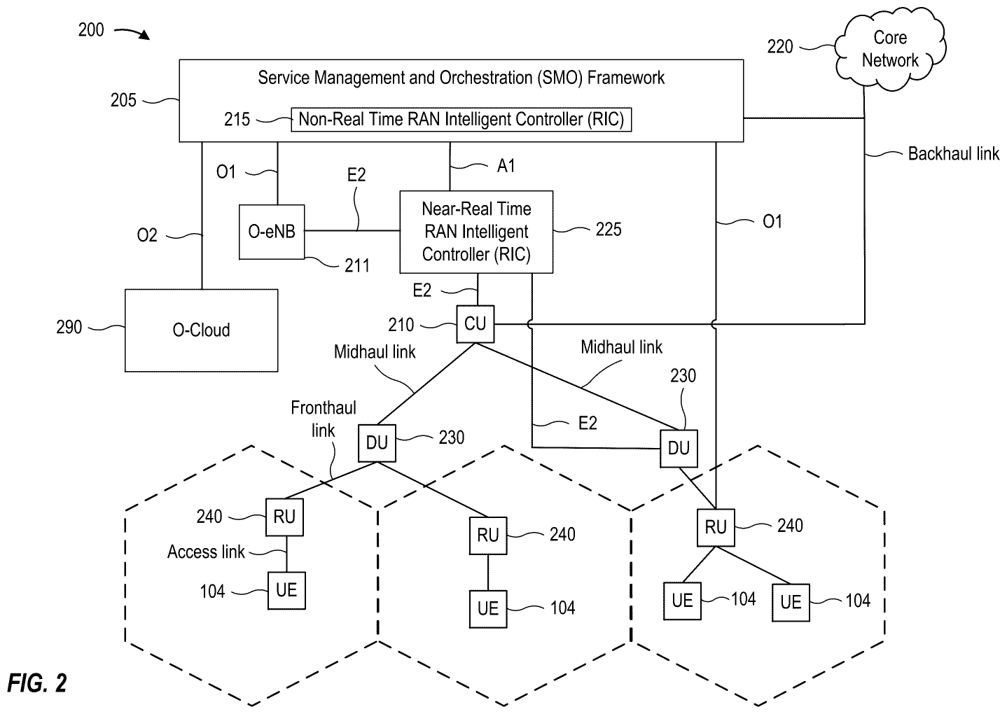

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHZ, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mm Wave/near mm Wave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

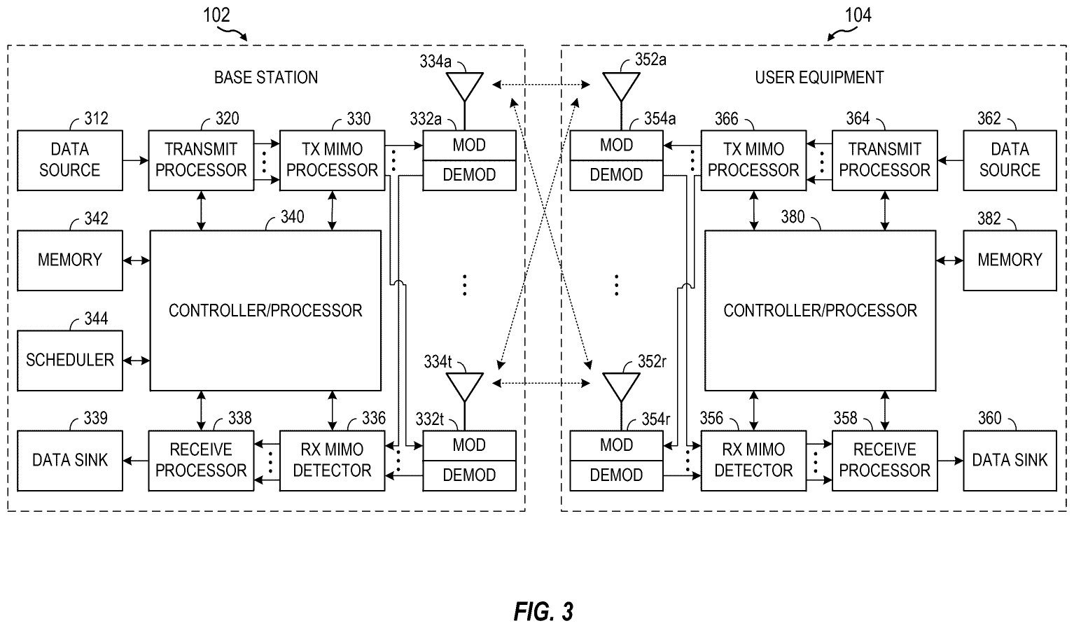

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, one or more processors may be configured to perform various operations, such as those associated with the methods described herein, and transmit (output) to or receive (obtain) data from another interface that is configured to transmit or receive, respectively, the data.

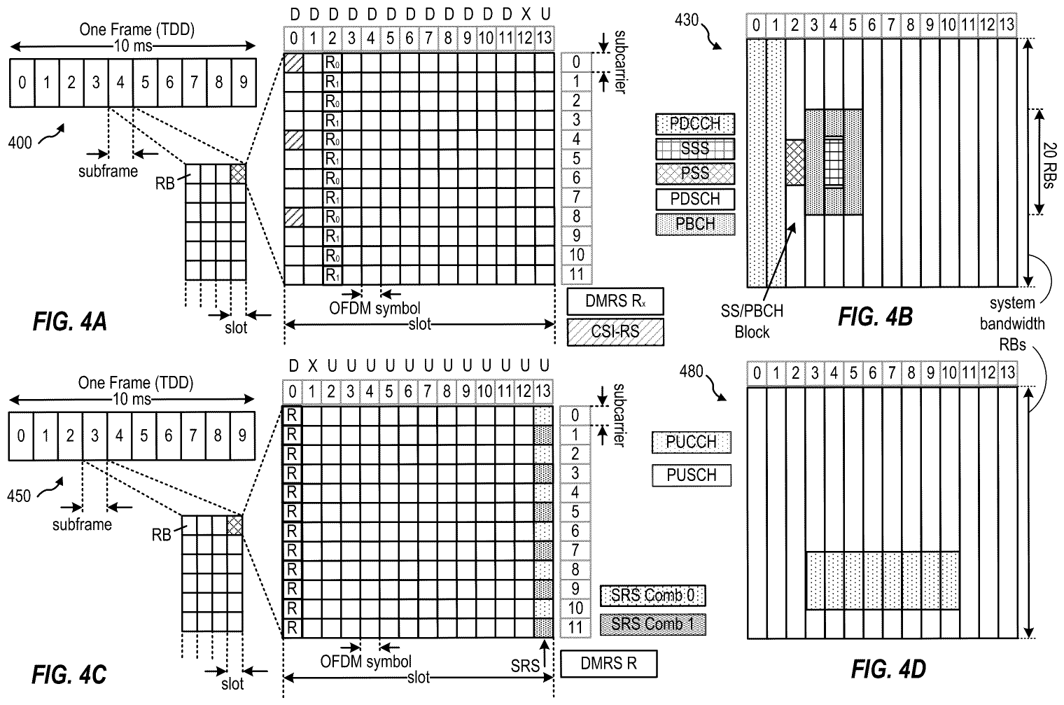

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 6 allow for 1, 2, 4, 8, 16, 32, and 64 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where u is the numerology 0 to 6. As such, the numerology μ=0 has a subcarrier spacing of 15 kHz and the numerology μ=6 has a subcarrier spacing of 960 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Singular Value Decomposition Combiner Precoding

One common approach of improving spectral efficiency in a closed-loop Orthogonal Frequency-Division Multiplexing Multiple Input Multiple Output (OFDM-MIMO) communication system involves precoding data using a singular value decomposition (SVD) precoder. This technique enables a wireless communications device, such as a network entity (e.g., BS 102) and/or a user equipment (e.g., UE 104), to transmit data through “strong” spatial directions of a wireless channel—that is, the spatial directions of the wireless channel where the signal-to-noise ratio (SNR) is maximized. In some cases, these techniques may involve multiplying a data streams vector (x) with a precoder (p) that includes singular vectors of the wireless channel (H) and transmitting a resulting precoded signal through the wireless channel, resulting in an equivalent precoded wireless channel (Hp).

SVD precoding has two main benefits. First, the signal transmitted through the stronger spatial directions of the wireless channel results in SNR of the signal being maximized. For example, assuming Nss is a number of spatial streams (layers), σ=[σ₁, σ₂, . . . ] is the channel's singular values (e.g., Eigen values of the matrix H^{H}H),

$${σ}_{n}^{2}$$

is the additive white Gaussian noise power at receive (Rx) antennas of a receiver device, and

$${σ}_{x}^{2}$$

is the transmitted power of the signal, the expected SNR of the i^{th} stream (1≤i≤Nss) is the baseline

$$SNR = {σ}_{x}^{2} / ( {σ}_{n}^{2} {N}_{ss} ) ,$$

multiplied by a gain of the i^{th} singular value of the channel, as shown in Equation 1.

$${SNR}_{i} = {σ}_{i}^{2} \cdot SNR = \frac{{σ}_{i}^{2} {σ}_{x}^{2}}{{N}_{ss} {σ}_{n}^{2}} \qquad ( 1 )$$

Another benefit of SVD is that the MIMO system resulting from SVD is equivalent to a system of Nss parallel single input single output (SISO) links, thereby reducing demodulation complexity at the receiver device. For example, the SVD precoder leads to a precoded channel Hp that is easy to equalize since it is diagonal, which leads to significant reduction in the demodulation complexity. More specifically, SVD precoding reduces the complexity of matrix inversion (e.g., o(n\hat{ }3)) to the complexity of diagonal matrix inversion (e.g., o(n)), where o is an upper bound of an inversion algorithm complexity and n is the matrix dimension. In some cases, o(n\hat{ }3) means that the algorithm require c*n\hat{ }3 summation and multiplication, where c is a nature constant.

However, while SVD precoding may result in SNR being maximized in certain spatial directions of the wireless channel, this benefit is constrained by the fact that all layers/streams transmitted through the wireless channel must use the same modulation and coding scheme (MCS). For example, since each transmitted stream/layer may have a different SNR resulting from Equation 1, each stream would ideally require a different MCS to maximize its corresponding SNR gain. However, certain restrictions may not allow for multiple MCSs to be used for different streams/layers, rendering the SVD precoder to be sub-optimal.

For example, in a single MCS scenario, the weakest stream—associated with the weakest singular value per Equation 1—may limit the overall data transmission throughput associated with the SVD precoder. As such, the MCS must be configured to ensure successful demodulation and decoding for all streams, particularly the one with the weakest SNR.

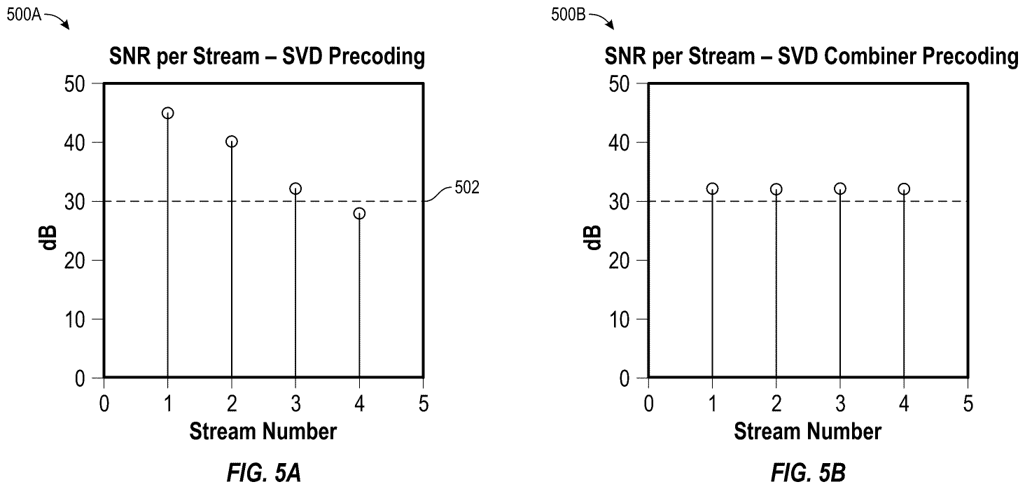

FIG. 5A illustrates an example of how a stream with a weakest SNR may limit throughput associated with SVD precoding. For example, as shown, FIG. 5A includes a graph 500A that plots SNRs of four different streams (e.g., Nₛₛ=4) when a conventional SVD precoder is used to precode data for transmission over a downlink channel. For example, as shown, the four streams have SNRs of 45 dB, 40 dB, 32 dB, and 28 dB, respectively.

As shown at 502, if demodulation of a particular MCS requires an SNR threshold of 30 dB (e.g., 1 k-QAM) and even though three out of the four layers have a higher SNR than the 30 dB threshold, demodulation of data transmitted across the four streams using the particular MCS may be expected to fail since an SNR of the fourth stream is below the 30 dB threshold. For example, as can be seen, the SNR of the fourth stream is approximately 28 dB. As a result, the fourth steam having the weakest SNR may control selection of an MCS for transmitting the data even though the three other streams have a higher SNR.

For example, to allow for successful demodulation in such a scenario, the MCS would need to be downgraded to a lower MCS that can be successfully decoded at the lower SNR associated with the fourth stream. More specifically, an MCS that is capable of supporting a 28 dB SNR may need to be selected for data transmission in order to ensure all four streams are correctly decoded. However, reducing the MCS may reduce an overall throughput of the transmitted data, which negatively affects user experience. Moreover, this problem persists even with the use of interleavers across the different streams since each code block of transmitted data may still experience all four levels of SNR associated with the different streams. Consequently, the lowest SNR may still control the MCS that is selected for transmitting the data. In other words, selection of the MCS for transmitting data is controlled by the stream having the lowest SNR in order to ensure successful demodulation of all streams, resulting in sub-optimal performance or throughput when using SVD in a single MCS scenario.

Accordingly, aspects of the present disclosure provide techniques for improving performance or throughput associated with transmitting data over a wireless channel. For example, in some cases, these techniques may involve using a SVD combiner precoder to precode a downlink signal for transmission to a UE. The SVD combiner precoder may be configured to combine the strongest singular Eigen vectors corresponding to singular values of a wireless downlink channel (e.g., H) equally among different streams in order to break the SNR difference between different streams. In other words, by using the SVD combiner precoder, the SNR of the “weakest” steam (e.g., the stream with the lowest SNR) may be improved such that all streams attain the same SNR. That is, each stream will benefit from an SNR which is an average SNR (e.g., average across the streams) of a traditional SVD precoding scheme. It should be appreciated that, while the techniques presented herein are described with respect to precoding a downlink signal using a SVD combiner precoder, these techniques may also be used to precode an uplink signal transmitted, for example, by a user equipment. In this case, the SVD combiner precoder may be configured to combine the Eigen vectors corresponding to the singular values of an uplink channel.

FIG. 5B illustrates an example of how the SNR of the “weakest” stream may be improved by using the SVD combiner precoder. For example, as shown, FIG. 5B includes a graph 500B that plots SNRs of the four different streams (e.g., Nₛₛ=4 shown in FIG. 5A) when an SVD combiner precoder is used to precode data for transmission over a downlink channel. As shown, as a result of the SVD combiner precoder, the SNRs of the four different streams shown in FIG. 5A (e.g., 45 dB, 40 dB, 32 dB, and 28 dB, respectively) may be improved and balanced, resulting in the four different streams each having an SNR of 32 dB (e.g., 32 dB, 32 dB, 32 dB, and 32 dB, respectively). Accordingly, rather than using an MCS that is capable of supporting an SNR of 28 dB, which may result in reduced data transmission throughput, an MCS that is capable of supporting an SNR of 32 dB may be used when the SVD combiner precoder is used, resulting in a higher data transmission throughput. Further, because the SNR of each stream is the same, each stream may be expected to have a similar or same demodulation performance at a receiver device in terms of error vector magnitude (EVM).

While the SVD combiner precoder may improve throughput, the SVD combiner precoder may be associated with an increase in demodulation complexity relative to the conventional SVD precoder. For example, the SVD precoder generates a MIMO system which is equivalent to Nss separated SISO links, which results in a significant reduction in the demodulation complexity (e.g., o(n) instead of o(n³)) due to an equalizer in a demodulator of a receiver device only having to invert a diagonal channel matrix (e.g., since the conventional SVD precoder leads to

$$( {H}^{H} H + {σ}_{n}^{2} I )$$

being diagonal, and only the later term needs to be inverted by the equalizer). In contrast, this SISO separation may not be attained when using the SVD combiner precoder, resulting in an increase in demodulation complexity (e.g., o(n³)) due to the general channel matrix that needs to be inverted rather than the diagonal channel matrix. Table 1, below, provides more details regarding the advantages and disadvantages of the SVD precoder and SVD combiner precoder in terms of transmission beamforming directions, throughput, and decoding complexity.

TABLE 1

| | SVD precoder | SVD combiner precoder |
|---|---|---|
| Transmission | Transmit the signal through the | Transmit the signal through |
| beam-forming | strongest directions of the channel | the strongest directions of |
| directions | | the channel |
| Channel | Lower capacity: Non equal SNR across | Higher throughput: Equal |
| Capacity | layers/layers (e.g., corresponding to | SNR across layers/streams |
| | the strongest singular values), leading | (e.g., corresponding to the |
| | to lower capacity or throughput due to | average strongest singular |
| | single MCS constraint across layers | values), leading leads to |
| | | higher capacity or throughput |
| | | even with a single MCS |
| | | constraint across layers |
| Decoding | Lower complexity: Layer/stream | Higher complexity: |
| Complexity | separation is guaranteed, leading | Layer/stream separation is |
| | to low demodulation complexity | not guaranteed, leading to a |
| | | high demodulation complexity |

As can be seen in Table 1, a UE may prefer use of the conventional SVD precoder and use of the SVD combiner precoder in different scenarios. For example, in a scenario in which the UE prefers higher throughput or capacity (e.g., to improve user experience, improve spectral efficiency, etc.), a network entity (e.g., BS 102) may be configured to use the SVD combiner precoder to precode downlink signals transmitted to the UE. In contrast, in a scenario in which UE prefer lower demodulation complexity (e.g., to conserve battery power, reduce latency, etc.), the network entity may be configured to use the conventional SVD precoder.

Accordingly, to better assist the network entity in selecting an appropriate precoder to use (e.g., the SVD precoder or the SVD combiner precoder) to precode downlink transmissions to the UE, aspects of the present disclosure provide techniques for providing downlink transmission preference information to the network entity. For example, as will be described in greater detail below, this downlink transmission preference of the UE may include at least one of a demodulation complexity preference of the UE or a downlink channel capacity preference of the UE.

For example, when the downlink transmission preference of the UE indicates at least one of a first demodulation complexity preference (e.g., high demodulation complexity or o(n\hat{ }3)) or a first downlink channel capacity preference (e.g., high downlink channel capacity or throughput), the network entity may be configured to select and use the SVD combiner precoder. In contrast, when the downlink transmission preference of the UE indicates at least one of a second demodulation complexity preference (e.g., low demodulation complexity or o(n)) or a second downlink channel capacity preference (e.g., low downlink channel capacity or throughput), the network entity may be configured to select and use the conventional SVD precoder.

### Example SVD Combiner Precoder

As noted above, the SVD combiner precoder may be configured to combine the strongest singular Eigen vectors corresponding to singular values of a wireless downlink channel (e.g., H) equally among different streams in order to break the SNR difference between different streams. When using the SVD combiner precoder, a downlink signal transmitted over the wireless downlink channel may be expressed by Equation 2, below.

$${y}_{k} = {H}_{k} {p}_{k} {x}_{k} + {n}_{k} \qquad ( 2 )$$

Assuming that N_{RX} is the number of receive (Rx) antennas at the UE, N_{TX} is the number of transmit (Tx) antennas at the network entity, and N_{SS} is the number of transmitted streams, in Equation 2, yₖ∈(NRX, 1) is the receive signal, Hₖ∈(Nrx, NTx) is the wireless downlink channel, pₖ∈(NTx, Nss) is the precoder, xₖ∈(Nss, 1) is the transmitted streams, nₖ∈(Nrx, 1) is the additive noise, and k is the frequency index.

In some cases, the conventional SVD precoder may suggest to use first strongest N_{SS} singular Eigen vectors as the precoder, as shown in Equation 3, below. In Equation 3, U_{K} is the left singular vectors matrix (e.g., including left singular vectors), Σₖ is the singular values matrix, and Vₖ is the right singular vectors matrix (e.g., including right singular vectors).

$${P}_{k} = {V}_{k} ( : , 1 : Nss ) , where ( svd ( {H}_{K} ) = {U}_{K} {\sum }_{k} {V}_{k}^{′} ) \qquad ( 3 )$$

If we assume also that the receiver multiplies yₖ by U′_{K}, the observed received signal may be represented by Equation 4, below.

$${\tilde{y}}_{k} = {U}_{K}^{′} {y}_{k} = {U}_{K}^{′} ( {H}_{k} {p}_{k} {x}_{k} + {n}_{k} ) = {U}_{K}^{′} {U}_{K} {\sum }_{k} {V}_{k}^{′} {V}_{k} {x}_{k} + {\tilde{n}}_{k} = {\sum }_{k} {x}_{k} + {\tilde{n}}_{k} \qquad ( 4 )$$

Accordingly, the resulting SNR for the i^{th} stream will be

$${SNR}_{i} = \frac{{σ}_{i}^{2} {σ}_{x}^{2}}{{N}_{ss} {σ}_{n}^{2}}$$

and each stream may be separated from the other streams.

To balance this SNR, an SVD combiner precoder, Pₖ, may be used, which may be based on a special square matrix, αₖ∈(Nss, Nss). For example, the SVD combiner precoder, Pₖ, may be represented by Equation 5, below.

$${P}_{k} = {V}_{k} ( : , 1 : Nss ) \cdot {α}_{k}$$

Further, to fully balance SNR between all the streams, each of entries in αₖ may have the same power. In some cases, this may be achieved by using a normalized Fast Fourier Transform (FFT) matrix represented by Equation 6, below.

$${α}_{k} ( m , n ) = \frac{1}{\sqrt{Nss}} exp ( - 2 π j \frac{nm}{Nss} ) 1 \leq m , n \leq Nss , \qquad ( 6 )$$

In some cases, each entry in αₖ may be selected to preserve the transmission power and have an independent columns. In this manner, we still gain the subspace of the strongest singular vectors as well as balance the different SNRs per stream.

### Example Operations for Configuring a Precoder for Downlink Transmissions

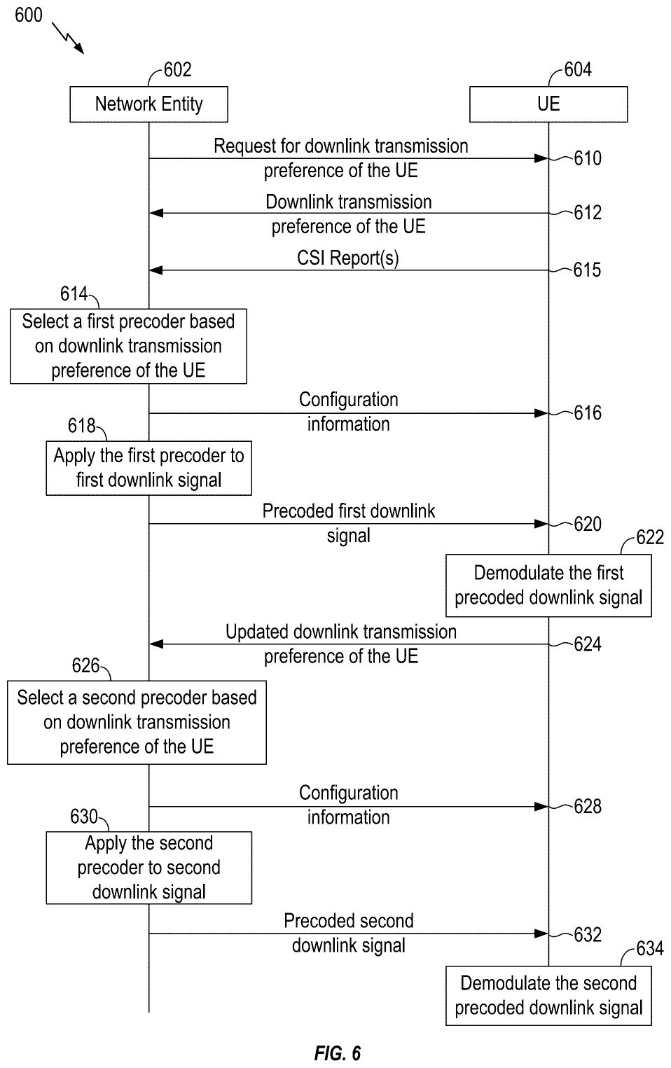

FIG. 6 depicts a process flow including operations 600 for communications in a network between a network entity 602 and a user equipment (UE) 604 for configuring a precoder, such as a conventional SVD precoder or an SVD combiner precoder, for downlink transmissions based on a downlink transmission preference of the UE 604. In some aspects, the network entity 602 may be an example of the BS 102 depicted and described with respect to FIGS. 1 and 3 or a disaggregated base station depicted and described with respect to FIG. 2. Similarly, the UE 604 may be an example of UE 104 depicted and described with respect to FIGS. 1 and 3. However, in other aspects, UE 104 may be another type of wireless communications device and BS 102 may be another type of network entity or network node, such as those described herein.

As shown, operations 600 begin at 610 with the network entity 602 transmitting, to the UE 604, a request for a downlink transmission preference of the UE 604. In some cases, the request may be transmitted to the UE in a media access control-control element (MAC-CE) at the beginning of communication with the UE 504, such as during cell attachment.

At 612, the network entity 602 receives, from the UE 604 after transmitting the request, a first message indicating the downlink transmission preference of the UE 604. In some cases, the network entity 602 may receive the first message from the UE 604 in a MAC-CE.

In some cases, the downlink transmission preference of the UE 604 comprises at least one of a demodulation complexity preference of the UE 604 or a downlink channel capacity preference of the UE 604. For example, the UE 604 may indicate to the network entity whether it prefers a higher throughput of capacity or whether the UE 604 prefers a lower demodulation complexity. By indicating a preference for a higher throughput or capacity, the UE 604 may implicitly indicate that the UE 604 also prefers a higher demodulation complexity. Similarly, by indicating a preference for a lower demodulation complexity, the UE 604 may implicitly indicate that the UE 604 also prefers a lower throughput or capacity. In some cases, the UE 604 may prefer lower demodulation complexity if it has power consumptions (e.g., a battery level of the UE 604 is at or below a power threshold) or latency limitations (e.g., the UE 604 is subject to a low latency limitation). In some cases, the UE 604 may prefer a higher capacity to optimize the spectral efficiency and improve user experience.

At 614, the network entity 602 selects, based on the downlink transmission preference of the UE 604, a first precoder for precoding a first downlink signal for transmission to the UE 604 on a wireless channel.

For example, in some cases, when the downlink transmission preference of the UE 604 indicates at least one of a first demodulation complexity preference (e.g., high demodulation complexity) or a first downlink channel capacity preference (e.g., high downlink channel capacity or throughput), the network entity 602 may be configured to select the SVD combiner precoder as the first precoder. As discussed above, the SVD combiner precoder may be configured to balance SNR across all transmission streams that will be used by the network entity 602 for transmitting a precoded downlink signal over a downlink channel, for example, by combining the Eigen vectors corresponding to the singular values of the downlink channel.

In some cases, when the downlink transmission preference of the UE 604 indicates at least one of a second demodulation complexity preference (e.g., low demodulation complexity) or a second downlink channel capacity preference (e.g., low downlink channel capacity or throughput), the network entity 602 may be configured to select the conventional SVD precoder. In some cases, the UE 604 may be configured to indicate at least one of the second demodulation complexity preference or the second downlink channel capacity preference when, at least one of a battery level of the UE 604 is at or below a threshold or the UE 604 has a low latency limitation.

In some cases, the network entity 602 may be configured to select the first precoder per precoding resource group (PRG) or for an entire transmission bandwidth (e.g., bandwidth part (BWP)) allocated for transmitting downlink signals, including the first downlink signal. For example, in some cases, the network entity 602 may select the conventional SVD precoder for a first PRG and may select the SVD combiner precoder for a second PRG. Alternatively, the network entity 602 may select one of the conventional SVD precoder or the SVD combiner precoder for the entire bandwidth/BWP.

In some cases, when selecting the first precoder, the network entity 602 may consider noise reported by the UE 604 (e.g., in channel state information (CSI) reports) and Eigen values of the downlink channel to estimate a gain of a channel capacity of the SVD combiner precoder with respect to the conventional SVD precoder. Based on the determined gain, the network entity 602 may decide whether the gain of the channel capacity of the SVD combiner precoder is worth the increase in demodulation complexity relative to the conventional SVD precoder. In some cases, the network entity 602 may also consider other criteria according to system needs when selecting the first precoder.

For example, in some cases, as shown at 615 in FIG. 6, the network entity 602 may receive one or more CSI reports from the UE 604 including CSI for the downlink channel. In some cases, the CSI for the downlink channel indicates at least one of a noise level associated with the downlink channel or Eigen values associated with the downlink channel. In some cases, the network entity 602 may be configured to select the first precoder further based on at least one of the noise level associated with the downlink channel or the Eigen values associated with the downlink channel. For example, in some cases, the network entity 602 may be configured to use the noise level and/or the Eigen values to estimate a gain associated with the SVD combiner precoder relative to a gain associated with the conventional SVD precoder.

In some cases, the network entity 602 may be configured to select the SVD combiner precoder as the first precoder when at least one of (1) the downlink transmission preference of the UE 604 indicates at least one of the first demodulation complexity preference or the first downlink channel capacity preference or (2) a gain associated with the SVD combiner precoder is a threshold amount higher than a gain associated with the SVD precoder. Alternatively, in some cases, the network entity 602 may be configured to select the conventional SVD precoder as the first precoder when at least one of (1) the downlink transmission preference of the UE 604 indicates at least one of the first demodulation complexity preference or the first downlink channel capacity preference or (2) a gain associated with the SVD combiner precoder is a threshold amount higher than a gain associated with the SVD precoder.

At 616, the network entity 602 transmits configuration information to the UE 604 comprising an indication of the first precoder. In some cases, the configuration message may be transmitted by the network entity 602 to the UE 604 using physical (PHY) layer signaling, such as within downlink control information (DCI) or in a physical downlink control channel (PDCCH). In some cases, the configuration information may indicate the selected first precoder per PRG or for the entire bandwidth/BWP.

In some cases, the indication of the first precoder indicates at least one of a demodulation complexity associated with the first precoder or a downlink channel capacity associated with the first precoder. In some cases, when the SVD combiner precoder is selected as the first precoder, the network entity 602 may be configured to provide an additional indication to the UE 604 regarding expected losses (e.g., in terms of dB or in terms of bits) associated with the use of different demodulators that may be used by the UE 604 to demodulate a precoded downlink signal from the network entity 602. In some case, the different demodulators may comprise, for example, a linear minimum mean square error (LMMSE) demodulator and a per-stream recursive demapping (PSRD) demodulator.

At 618 in FIG. 6, the network entity 602 applies the first precoder, selected based on the downlink transmission preference of the UE 604, to the first downlink signal for transmission to the UE 604.

At 620, the network entity 602 transmits the precoded first downlink signal to the UE 604 over a downlink channel using a plurality of transmission streams

At 622, the UE 604 demodulates the precoded first downlink signal using a first demodulator corresponding to the first precoder. In some cases, the UE 604 may determine the first demodulator based on channel estimation measurements used to estimate the wireless channel.

In some cases, when the first precoder comprises the conventional SVD precoder, the UE 604 may determine or select a lower complexity demodulator, such as a demodulator capable of diagonal matrix inversion or conjugate gradients approximation.

In some cases, when the first precoder comprises the SVD combiner precoder, the UE 604 may determine or select a more advanced or complex demodulator, such as an LMMSE demodulator with full matrix demodulation or a PRSD demodulator.

In some cases, the UE 604 may determine or select the first demodulator further based on the indicated expected demodulation losses for the different demodulators of the plurality demodulators. For example, in some cases, if the expected demodulation losses are relatively high (e.g., at or above a threshold dB or threshold number of bits) the UE 604 may select a more advanced demodulator, such as the PSRD demodulator, whereas if the expected demodulation losses are lower (e.g., below the threshold dB or threshold number of bits), the UE 604 may select a more standard or less advanced demodulator (e.g., relative to the PRSD demodulator), such as the LMMSE demodulator with full matrix demodulation, to avoid an increase in demodulation complexity associated with the PSRD and to conserve battery power.

In some cases, at 624, the UE 604 may transmit a second message to the network entity 602 indicating updated downlink transmission preference of the UE 604. In some cases, the UE 604 may transmit the second message in a physical uplink control channel (PUCCH) or a physical uplink shared channel (PUSCH). In some cases, the updated downlink transmission preference of the UE 604 may comprise an updated demodulation complexity preference of the UE 604 that is different from the demodulation complexity preference of the UE 604. In some cases, the updated downlink transmission preference of the UE 604 may comprise an updated downlink channel capacity preference of the UE 604 that is different from the downlink channel capacity preference of the UE 604.

In some cases, the UE 604 may update its downlink transmission preference based on a change in operating conditions. In some cases, the change in operating conditions may include a change in a battery level. For example, if the first precoder used to precode the first downlink signal was the SVD combiner precoder and the battery level of the UE 604 meets or drops below a threshold power level, the UE 604 may decide to reduce its demodulation complexity to conserve battery power. In such cases, the UE 604 may be configured to indicate, in the updated downlink transmission preference, at least one of the second demodulation complexity preference (e.g., low demodulation complexity) or the second downlink channel capacity preference (e.g., low downlink channel capacity or throughput), so that the network entity 602 selects a new precoder, such as the conventional SVD precoder, to precode downlink signals, which is associated with a lower demodulation complexity and lower power consumption.

Alternatively, if the first precoder used to precode the first downlink signal was the conventional SVD precoder and the battery level of the UE 604 rises above the threshold power level, the UE 604 may prefer spectral efficiency and increased throughput/capacity. In this case, the UE 604 may indicate, in the updated downlink transmission preference, at least one of the first demodulation complexity preference (e.g., high demodulation complexity) or the first downlink channel capacity preference (e.g., high downlink channel capacity or throughput), so that the network entity 602 selects a new precoder, such as the SVD combiner precoder, to precode downlink signals, which is associated with an increase in spectral efficiency and channel throughput/capacity.

In some cases, the change in operating conditions may include a change in transmission latency requirements associated with the UE 604. In some cases, the latency requirement may represent an amount of time that the UE 604 is expected to receive, decode, and respond to a downlink signal from the network entity 602. For example, if the first precoder used to precode the first downlink signal was the SVD combiner precoder and a transmission latency requirement associated with the UE 604 falls below a latency threshold (e.g., indicating the UE 604 has less time to receive, decode, and respond to downlink signals), the UE 604 may decide to reduce its demodulation complexity, which may decrease its transmission latency while also conserving battery power.

For example, because the transmission latency requirement falls below the latency threshold, the UE 604 may indicate, in the updated downlink transmission preference, at least one of the second demodulation complexity preference (e.g., low demodulation complexity) or the second downlink channel capacity preference (e.g., low downlink channel capacity or throughput), so that the network entity 602 selects a new precoder, such as the conventional SVD precoder, to precode downlink signals, which is associated with a lower demodulation complexity, lower power consumption, and lower latency.

Alternatively, if the first precoder used to precode the first downlink signal was the conventional SVD precoder and the transmission latency requirement associated with the UE 604 increases above the latency threshold (e.g., indicating the UE 604 has more time to receive, decode, and respond to downlink signals), the UE 604 may prefer higher channel throughput/capacity and may decide to increase its demodulation complexity as the UE 504 has additional time to receive, decode, and respond to downlink signals. For example, because the transmission latency requirement has increased above the latency threshold and because the UE 604 has more time to receive, decode, and respond to downlink signals, the UE 604 may indicate, in the updated downlink transmission preference, at least one of the first demodulation complexity preference (e.g., high demodulation complexity) or the first downlink channel capacity preference (e.g., high downlink channel capacity or throughput), so that the network entity 602 selects a new precoder, such as the SVD combiner precoder, to precode downlink signals, which is associated with an increase in spectral efficiency and channel throughput/capacity.

In some cases, the change in the operating conditions may include a change in a temperature of the UE 604. For example, in some cases, when the first precoder used to precode the first downlink signal was an SVD combiner precoder and the temperature of the UE 604 (or one or more components in the UE 604, such as a processor, modem, memory, etc.) rises above or meets a certain temperature threshold, the UE 604 may decide to reduce its demodulation complexity to reduce the temperature of the UE 504. For example, the UE 604 may indicate, in the updated downlink transmission preference, at least one of the second demodulation complexity preference (e.g., low demodulation complexity) or the second downlink channel capacity preference (e.g., low downlink channel capacity or throughput), so that the network entity 602 selects a new precoder, such as the conventional SVD precoder, to precode downlink signals, which is associated with a lower demodulation complexity, thereby reducing temperature of the UE 604.

Alternatively, if the first precoder used to precode the first downlink signal was the conventional SVD precoder and the temperature of the UE 504 (or one or more components in the UE 504, such as a processor, modem, memory, etc.) falls below the certain temperature threshold, the UE 604 may prefer higher channel throughput/capacity and may increase its demodulation complexity since the temperature of the UE 604 is below the temperature threshold and the UE 604 is able to handle an increase in processing resources or power associated with more complex demodulation. For example, in this case, the UE 604 may indicate, in the updated downlink transmission preference, at least one of the first demodulation complexity preference (e.g., high demodulation complexity) or the first downlink channel capacity preference (e.g., high downlink channel capacity or throughput), so that the network entity 602 selects a new precoder, such as the SVD combiner precoder, to precode downlink signals, which is associated with an increase in spectral efficiency and channel throughput/capacity. While the SVD combiner precoder may increase the processing resources or power associated with demodulating these downlink signals at the UE 604, this may be acceptable as the temperature of the UE 604 is below the temperature threshold.

As shown at 626, the network entity 602 selects, based on the updated downlink transmission preference of the UE 604, a second precoder for precoding a second downlink signal for transmission to the UE 604 over the downlink channel using the plurality of transmission streams. In some cases, the first precoder may be different from second precoder.

At 628, the network entity 602 transmits additional configuration information associated with the second precoder. The additional configuration information may be similar or indicate similar information as the configuration information described with respect to step 616, described above. For example, the additional configuration information include an indication of the second precoder. In some cases, the additional configuration message may be transmitted by the network entity 602 to the UE 604 using PHY layer signaling, such as within DCI or in a PDCCH. In some cases, the configuration information may indicate the selected first precoder per PRG or for the entire bandwidth/BWP

At 630, the network entity applies the second precoder, selected based on the updated demodulation capability of the UE 604, to a second downlink signal for transmission to the UE 604.

At 632, the network entity 602 transmits the precoded second downlink signal to the UE 604 UE over the downlink channel using the plurality of transmission streams.

At 634, the UE 604 demodulates the precoded second downlink signal using a second demodulator corresponding to the second precoder. In some cases, the second demodulator corresponding to the second precoder may be different from the first demodulator corresponding to the first precoder.

### Example Operations of a User Equipment

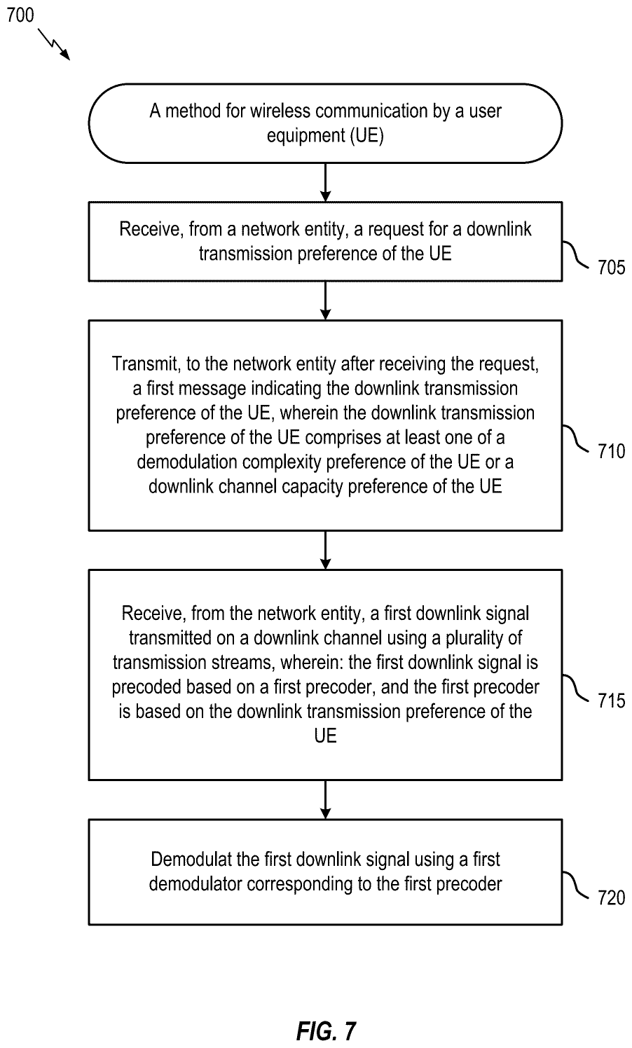

FIG. 7 shows an example of a method 700 of wireless communication by a user equipment (UE), such as a UE 104 of FIGS. 1 and 3.

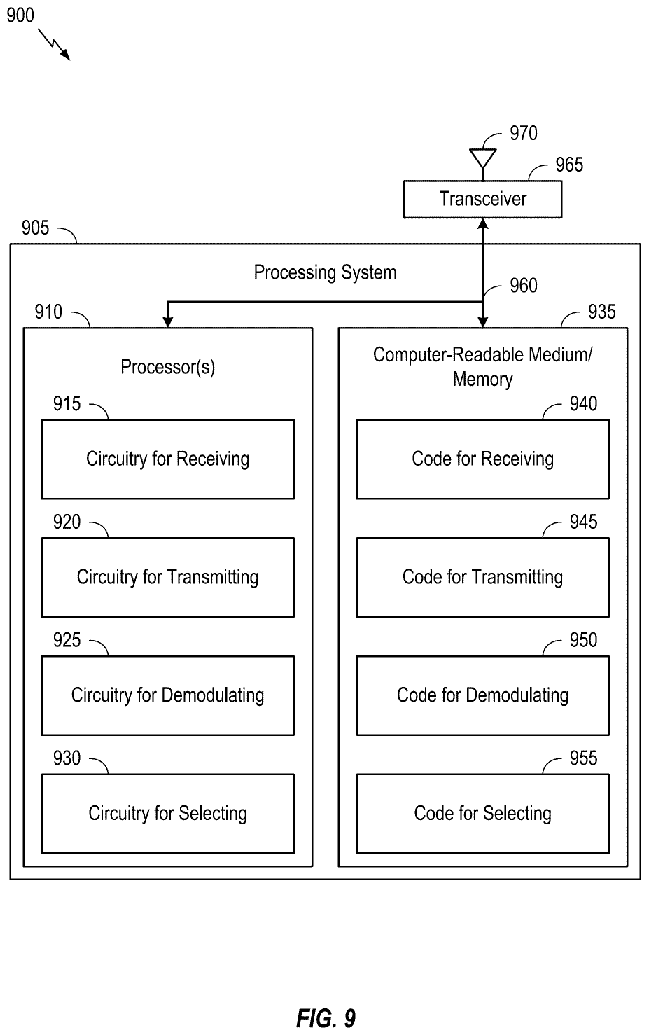

Method 700 begins at step 705 with receiving, from a network entity, a request for a downlink transmission preference of the UE. In some cases, the operations of this step refer to, or may be performed by, circuitry for receiving and/or code for receiving as described with reference to FIG. 9.

Method 700 then proceeds to step 710 with transmitting, to the network entity after receiving the request, a first message indicating the downlink transmission preference of the UE, wherein the downlink transmission preference of the UE comprises at least one of a demodulation complexity preference of the UE or a downlink channel capacity preference of the UE. In some cases, the operations of this step refer to, or may be performed by, circuitry for transmitting and/or code for transmitting as described with reference to FIG. 9.

Method 700 then proceeds to step 715 with receiving, from the network entity, a first downlink signal transmitted on a downlink channel using a plurality of transmission streams, wherein: the first downlink signal is precoded based on a first precoder, and the first precoder is based on the downlink transmission preference of the UE. In some cases, the operations of this step refer to, or may be performed by, circuitry for receiving and/or code for receiving as described with reference to FIG. 9.

Method 700 then proceeds to step 720 with demodulating the first downlink signal using a first demodulator corresponding to the first precoder. In some cases, the operations of this step refer to, or may be performed by, circuitry for demodulating and/or code for demodulating as described with reference to FIG. 9.

In some aspects, when the downlink transmission preference of the UE indicates at least one of a first demodulation complexity preference or a first downlink channel capacity preference, the first precoder comprises a singular value decomposition (SVD) combiner precoder; and when the downlink transmission preference of the UE indicates at least one of a second demodulation complexity preference or a second downlink channel capacity preference, the first precoder comprises a conventional SVD precoder.

In some aspects, the SVD combiner precoder is configured to: combine Eigen vectors corresponding to singular values of the downlink channel; and balance a signal to noise ratio (SNR) across all transmission streams of the plurality of transmission streams.

In some aspects, the first demodulation complexity preference is higher than the second demodulation complexity preference; and the first downlink channel capacity preference is higher than the second downlink channel capacity preference.

In some aspects, when first precoder comprises the SVD combiner precoder, the first demodulator comprises one of a per-stream recursive demapping (PSRD) demodulator or a linear minimum mean-squared error (LMMSE) demodulator; and when the first precoder comprises the conventional SVD precoder, the first demodulator comprises one of a diagonal matrix inversion demodulator or a conjugate gradients approximation demodulator.

In some aspects, the downlink transmission preference of the UE indicates at least one of the second demodulation complexity preference or the second downlink channel capacity preference when, at least one of: a battery level of the UE is at or below a threshold; or the UE has a low latency limitation.

In some aspects, the method 700 further includes transmitting channel state information (CSI) for the downlink channel to the network entity. In some cases, the operations of this step refer to, or may be performed by, circuitry for transmitting and/or code for transmitting as described with reference to FIG. 9.

In some aspects, the CSI for the downlink channel indicates at least one of a noise level associated with the downlink channel or Eigen values associated with the downlink channel.

In some aspects, the first precoder is further based on at least one of the noise level associated with the downlink channel or the Eigen values associated with the downlink channel.

In some aspects, the method 700 further includes receiving, from the network entity, a second message comprising an indication of the first precoder. In some cases, the operations of this step refer to, or may be performed by, circuitry for receiving and/or code for receiving as described with reference to FIG. 9.

In some aspects, the indication of the first precoder indicates at least one of a demodulation complexity associated with the first precoder or a downlink channel capacity associated with the first precoder; and the method further comprises selecting the first demodulator based on at least one of the demodulation complexity associated with the first precoder or the downlink channel capacity associated with the first precoder.

In some aspects, the indication of the first precoder indicates: the first precoder comprises a singular value decomposition (SVD) combiner precoder; and demodulation losses, in terms of decibels (dB) or bits, for different demodulators of a plurality demodulators for use in demodulating the precoded first downlink signal.

In some aspects, the different demodulators comprise at least one of: a per-stream recursive demapping (PSRD) demodulator; or a linear minimum mean-squared error (LMMSE) demodulator.

In some aspects, the method 700 further includes selecting the first demodulator further based on the indicated demodulation losses for the different demodulators of the plurality demodulators. In some cases, the operations of this step refer to, or may be performed by, circuitry for selecting and/or code for selecting as described with reference to FIG. 9.

In some aspects, the method 700 further includes transmitting an updated downlink transmission preference of the UE, wherein: the updated downlink transmission preference of the UE comprises at least one of: an updated demodulation complexity preference of the UE that is different from the demodulation complexity preference of the UE, or an updated downlink channel capacity preference of the UE that is different from the downlink channel capacity preference of the UE. In some cases, the operations of this step refer to, or may be performed by, circuitry for transmitting and/or code for transmitting as described with reference to FIG. 9.

In some aspects, the method 700 further includes receiving, from the network entity, a second downlink signal transmitted on the downlink channel using the plurality of transmission streams, wherein: the second downlink signal is precoded based on a second precoder that is different from the first precoder, the second precoder is based on the updated downlink transmission preference of the UE, the method further comprises demodulating the second downlink signal using a second demodulator corresponding to the second precoder, and the second demodulator is different from the first demodulator. In some cases, the operations of this step refer to, or may be performed by, circuitry for receiving and/or code for receiving as described with reference to FIG. 9.

In some aspects, the method 700 further includes receiving the request from the network entity in a media access control-control element (MAC-CE). In some cases, the operations of this step refer to, or may be performed by, circuitry for receiving and/or code for receiving as described with reference to FIG. 9.

In some aspects, the method 700 further includes transmitting the first message to the network entity in a MAC-CE. In some cases, the operations of this step refer to, or may be performed by, circuitry for transmitting and/or code for transmitting as described with reference to FIG. 9.

In one aspect, method 700, or any aspect related to it, may be performed by an apparatus, such as communications device 900 of FIG. 9, which includes various components operable, configured, or adapted to perform the method 700. Communications device 900 is described below in further detail.

Note that FIG. 7 is just one example of a method, and other methods including fewer, additional, or alternative steps are possible consistent with this disclosure.

### Example Operations of a Network Entity

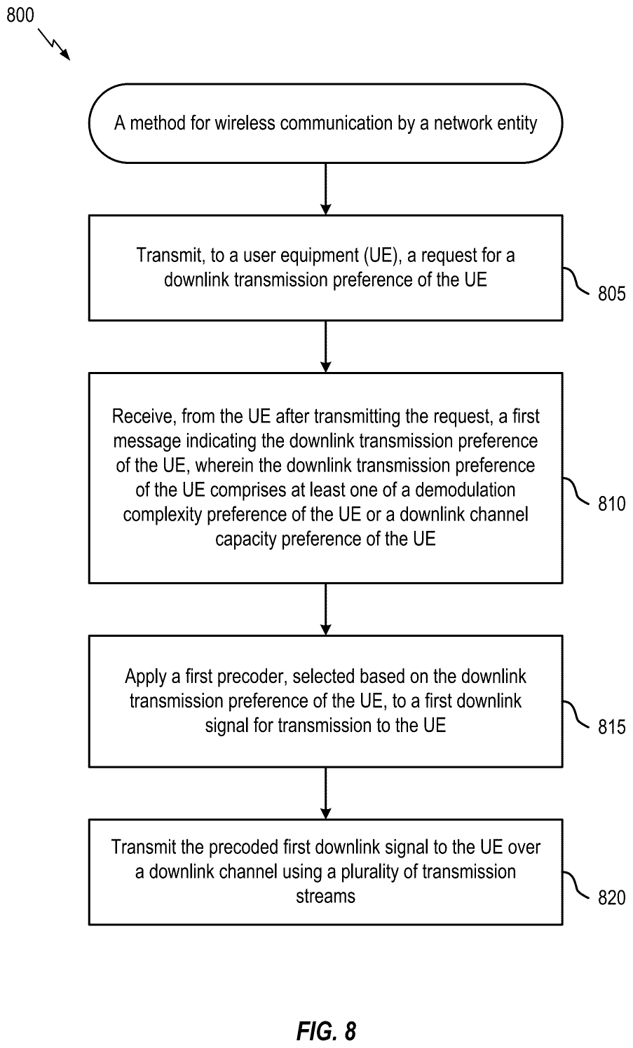

FIG. 8 shows an example of a method 800 of wireless communication by a network entity, such as a BS 102 of FIGS. 1 and 3, or a disaggregated base station as discussed with respect to FIG. 2.

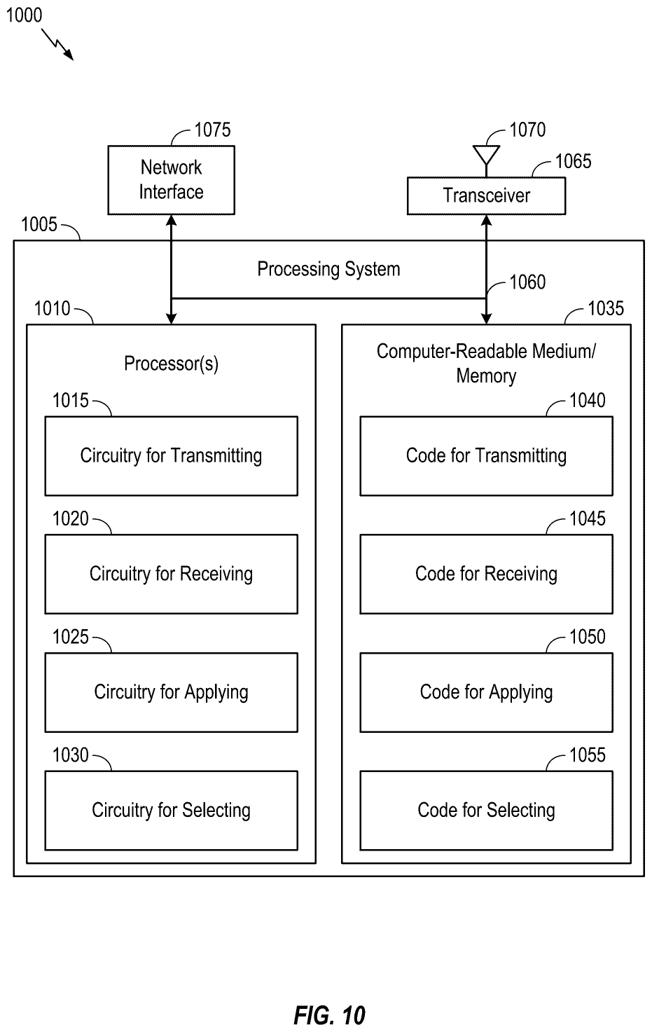

Method 800 begins at step 805 with transmitting, to a user equipment (UE), a request for a downlink transmission preference of the UE. In some cases, the operations of this step refer to, or may be performed by, circuitry for transmitting and/or code for transmitting as described with reference to FIG. 10.

Method 800 then proceeds to step 810 with receiving, from the UE after transmitting the request, a first message indicating the downlink transmission preference of the UE, wherein the downlink transmission preference of the UE comprises at least one of a demodulation complexity preference of the UE or a downlink channel capacity preference of the UE. In some cases, the operations of this step refer to, or may be performed by, circuitry for receiving and/or code for receiving as described with reference to FIG. 10.

Method 800 then proceeds to step 815 with applying a first precoder, selected based on the downlink transmission preference of the UE, to a first downlink signal for transmission to the UE. In some cases, the operations of this step refer to, or may be performed by, circuitry for applying and/or code for applying as described with reference to FIG. 10.

Method 800 then proceeds to step 820 with transmitting the precoded first downlink signal to the UE over a downlink channel using a plurality of transmission streams. In some cases, the operations of this step refer to, or may be performed by, circuitry for transmitting and/or code for transmitting as described with reference to FIG. 10.

In some aspects, when the downlink transmission preference of the UE indicates at least one of a first demodulation complexity preference or a first downlink channel capacity preference, the first precoder comprises a singular value decomposition (SVD) combiner precoder; and when the downlink transmission preference of the UE indicates at least one of a second demodulation complexity preference or a second downlink channel capacity preference, the first precoder comprises a conventional SVD precoder.

In some aspects, the SVD combiner precoder is configured to: combine Eigen vectors corresponding to singular values of the downlink channel; and balance a signal to noise ratio (SNR) across all transmission streams of the plurality of transmission streams.

In some aspects, the first demodulation complexity preference is higher than the second demodulation complexity preference, and the first downlink channel capacity preference is higher than the second downlink channel capacity preference.

In some aspects, the method 800 further includes selecting the SVD combiner precoder when: the downlink transmission preference of the UE indicates at least one of the first demodulation complexity preference or the first downlink channel capacity preference, and a gain associated with the SVD combiner precoder is a threshold amount higher than a gain associated with the SVD precoder. In some cases, the operations of this step refer to, or may be performed by, circuitry for selecting and/or code for selecting as described with reference to FIG. 10.

In some aspects, the method 800 further includes receiving channel state information (CSI) for the downlink channel from the UE. In some cases, the operations of this step refer to, or may be performed by, circuitry for receiving and/or code for receiving as described with reference to FIG. 10.

In some aspects, the CSI for the downlink channel indicates at least one of a noise level associated with the downlink channel or Eigen values associated with the downlink channel.

In some aspects, the method 800 further includes selecting the first precoder further based on at least one of the noise level associated with the downlink channel or the Eigen values associated with the downlink channel. In some cases, the operations of this step refer to, or may be performed by, circuitry for selecting and/or code for selecting as described with reference to FIG. 10.

In some aspects, the method 800 further includes transmitting, to the UE, configuration information comprising an indication of the first precoder. In some cases, the operations of this step refer to, or may be performed by, circuitry for transmitting and/or code for transmitting as described with reference to FIG. 10.

In some aspects, the indication of the first precoder indicates at least one of a demodulation complexity associated with the first precoder or a downlink channel capacity associated with the first precoder.

In some aspects, the indication of the first precoder indicates: the first precoder comprises a singular value decomposition (SVD) combiner precoder; and demodulation losses, in terms of decibels (dB) or bits, for different demodulators of a plurality demodulators for use in demodulating the precoded first downlink signal.

In some aspects, the different demodulators comprise at least one of: a per-stream recursive demapping (PSRD) demodulator; or a linear minimum mean-squared error (LMMSE) demodulator.

In some aspects, the method 800 further includes receiving an updated downlink transmission preference of the UE, wherein: the updated downlink transmission preference of the UE comprises at least one of: an updated demodulation complexity preference of the UE that is different from the demodulation complexity preference of the UE, or an updated downlink channel capacity preference of the UE that is different from the downlink channel capacity preference of the UE. In some cases, the operations of this step refer to, or may be performed by, circuitry for receiving and/or code for receiving as described with reference to FIG. 10.

In some aspects, the method 800 further includes applying a second precoder, selected based on the updated downlink transmission preference of the UE, to a second downlink signal for transmission to the UE. In some cases, the operations of this step refer to, or may be performed by, circuitry for applying and/or code for applying as described with reference to FIG. 10.

In some aspects, the method 800 further includes transmitting the precoded second downlink signal to the UE over the downlink channel using the plurality of transmission streams, wherein the first precoder is different from the second precoder. In some cases, the operations of this step refer to, or may be performed by, circuitry for transmitting and/or code for transmitting as described with reference to FIG. 10.

In some aspects, the method 800 further includes transmitting the request to the UE in a media access control-control element (MAC-CE). In some cases, the operations of this step refer to, or may be performed by, circuitry for transmitting and/or code for transmitting as described with reference to FIG. 10.

In some aspects, the method 800 further includes receiving the first message from the UE in a MAC-CE. In some cases, the operations of this step refer to, or may be performed by, circuitry for receiving and/or code for receiving as described with reference to FIG. 10.

In one aspect, method 800, or any aspect related to it, may be performed by an apparatus, such as communications device 1000 of FIG. 10, which includes various components operable, configured, or adapted to perform the method 800. Communications device 1000 is described below in further detail.

Note that FIG. 8 is just one example of a method, and other methods including fewer, additional, or alternative steps are possible consistent with this disclosure.

### Example Communications Device(s)

FIG. 9 depicts aspects of an example communications device 900. In some aspects, communications device 900 is a user equipment, such as UE 104 described above with respect to FIGS. 1 and 3.

The communications device 900 includes a processing system 905 coupled to the transceiver 965 (e.g., a transmitter and/or a receiver). The transceiver 965 is configured to transmit and receive signals for the communications device 900 via the antenna 970, such as the various signals as described herein. The processing system 905 may be configured to perform processing functions for the communications device 900, including processing signals received and/or to be transmitted by the communications device 900.

The processing system 905 includes one or more processors 910. In various aspects, the one or more processors 910 may be representative of one or more of receive processor 358, transmit processor 364, TX MIMO processor 366, and/or controller/processor 380, as described with respect to FIG. 3. The one or more processors 910 are coupled to a computer-readable medium/memory 935 via a bus 960. In certain aspects, the computer-readable medium/memory 935 is configured to store instructions (e.g., computer-executable code) that when executed by the one or more processors 910, cause the one or more processors 910 to perform the method 700 described with respect to FIG. 7, or any aspect related to it. Note that reference to a processor performing a function of communications device 900 may include one or more processors 910 performing that function of communications device 900.

In the depicted example, computer-readable medium/memory 935 stores code (e.g., executable instructions), such as code for receiving 940, code for transmitting 945, code for demodulating 950, and code for selecting 955. Processing of the code for receiving 940, code for transmitting 945, code for demodulating 950, and code for selecting 955 may cause the communications device 900 to perform the method 700 described with respect to FIG. 7, or any aspect related to it.

The one or more processors 910 include circuitry configured to implement (e.g., execute) the code stored in the computer-readable medium/memory 935, including circuitry such as circuitry for receiving 915, circuitry for transmitting 920, circuitry for demodulating 925, and circuitry for selecting 930. Processing with circuitry for receiving 915, circuitry for transmitting 920, circuitry for demodulating 925, and circuitry for selecting 930 may cause the communications device 900 to perform the method 700 described with respect to FIG. 7, or any aspect related to it.

Various components of the communications device 900 may provide means for performing the method 700 described with respect to FIG. 7, or any aspect related to it. For example, means for transmitting, sending or outputting for transmission may include transceivers 354 and/or antenna(s) 352 of the UE 104 illustrated in FIG. 3 and/or the transceiver 965 and the antenna 970 of the communications device 900 in FIG. 9. Means for receiving or obtaining may include transceivers 354 and/or antenna(s) 352 of the UE 104 illustrated in FIG. 3 and/or the transceiver 965 and the antenna 970 of the communications device 900 in FIG. 9.

FIG. 10 depicts aspects of an example communications device 1000. In some aspects, communications device 1000 is a network entity, such as BS 102 of FIGS. 1 and 3, or a disaggregated base station as discussed with respect to FIG. 2.

The communications device 1000 includes a processing system 1005 coupled to the transceiver 1065 (e.g., a transmitter and/or a receiver) and/or a network interface 1075. The transceiver 1065 is configured to transmit and receive signals for the communications device 1000 via the antenna 1070, such as the various signals as described herein. The network interface 1075 is configured to obtain and send signals for the communications device 1000 via communication link(s), such as a backhaul link, midhaul link, and/or fronthaul link as described herein, such as with respect to FIG. 2. The processing system 1005 may be configured to perform processing functions for the communications device 1000, including processing signals received and/or to be transmitted by the communications device 1000.

The processing system 1005 includes one or more processors 1010. In various aspects, one or more processors 1010 may be representative of one or more of receive processor 338, transmit processor 320, TX MIMO processor 330, and/or controller/processor 340, as described with respect to FIG. 3. The one or more processors 1010 are coupled to a computer-readable medium/memory 1035 via a bus 1060. In certain aspects, the computer-readable medium/memory 1035 is configured to store instructions (e.g., computer-executable code) that when executed by the one or more processors 1010, cause the one or more processors 1010 to perform the method 800 described with respect to FIG. 8, or any aspect related to it. Note that reference to a processor of communications device 1000 performing a function may include one or more processors 1010 of communications device 1000 performing that function.

In the depicted example, the computer-readable medium/memory 1035 stores code (e.g., executable instructions), such as code for transmitting 1040, code for receiving 1045, code for applying 1050, and code for selecting 1055. Processing of the code for transmitting 1040, code for receiving 1045, code for applying 1050, and code for selecting 1055 may cause the communications device 1000 to perform the method 800 described with respect to FIG. 8, or any aspect related to it.

The one or more processors 1010 include circuitry configured to implement (e.g., execute) the code stored in the computer-readable medium/memory 1035, including circuitry such as circuitry for transmitting 1015, circuitry for receiving 1020, circuitry for applying 1025, and circuitry for selecting 1030. Processing with circuitry for transmitting 1015, circuitry for receiving 1020, circuitry for applying 1025, and circuitry for selecting 1030 may cause the communications device 1000 to perform the method 800 described with respect to FIG. 8, or any aspect related to it.

Various components of the communications device 1000 may provide means for performing the method 800 described with respect to FIG. 8, or any aspect related to it. Means for transmitting, sending or outputting for transmission may include transceivers 332 and/or antenna(s) 334 of the BS 102 illustrated in FIG. 3 and/or the transceiver 1065 and the antenna 1070 of the communications device 1000 in FIG. 10. Means for receiving or obtaining may include transceivers 332 and/or antenna(s) 334 of the BS 102 illustrated in FIG. 3 and/or the transceiver 1065 and the antenna 1070 of the communications device 1000 in FIG. 10.

### Example Clauses

Implementation examples are described in the following numbered clauses:

Clause 1: A method for wireless communication by a network entity, comprising: transmitting, to a user equipment (UE), a request for a downlink transmission preference of the UE; receiving, from the UE after transmitting the request, a first message indicating the downlink transmission preference of the UE, wherein the downlink transmission preference of the UE comprises at least one of a demodulation complexity preference of the UE or a downlink channel capacity preference of the UE; applying a first precoder, selected based on the downlink transmission preference of the UE, to a first downlink signal for transmission to the UE; and transmitting the precoded first downlink signal to the UE over a downlink channel using a plurality of transmission streams.

Clause 2: The method of Clause 1, wherein: when the downlink transmission preference of the UE indicates at least one of a first demodulation complexity preference or a first downlink channel capacity preference, the first precoder comprises a singular value decomposition (SVD) combiner precoder; and when the downlink transmission preference of the UE indicates at least one of a second demodulation complexity preference or a second downlink channel capacity preference, the first precoder comprises a conventional SVD precoder.

Clause 3: The method of Clause 2, wherein the SVD combiner precoder is configured to: combine Eigen vectors corresponding to singular values of the downlink channel; and balance a signal to noise ratio (SNR) across all transmission streams of the plurality of transmission streams.

Clause 4: The method of Clause 2, wherein: the first demodulation complexity preference is higher than the second demodulation complexity preference, and the first downlink channel capacity preference is higher than the second downlink channel capacity preference.

Clause 5: The method of Clause 2, further comprising selecting the SVD combiner precoder when: the downlink transmission preference of the UE indicates at least one of the first demodulation complexity preference or the first downlink channel capacity preference, and a gain associated with the SVD combiner precoder is a threshold amount higher than a gain associated with the SVD precoder.

Clause 6: The method of any one of Clauses 1-5, further comprising receiving channel state information (CSI) for the downlink channel from the UE.

Clause 7: The method of Clause 6, wherein the CSI for the downlink channel indicates at least one of a noise level associated with the downlink channel or Eigen values associated with the downlink channel.

Clause 8: The method of Clause 7, further comprising selecting the first precoder further based on at least one of the noise level associated with the downlink channel or the Eigen values associated with the downlink channel.

Clause 9: The method of any one of Clauses 1-8, further comprising transmitting, to the UE, configuration information comprising an indication of the first precoder.

Clause 10: The method of Clause 9, wherein the indication of the first precoder indicates at least one of a demodulation complexity associated with the first precoder or a downlink channel capacity associated with the first precoder.

Clause 11: The method of Clause 9, wherein the indication of the first precoder indicates: the first precoder comprises a singular value decomposition (SVD) combiner precoder; and demodulation losses, in terms of decibels (dB) or bits, for different demodulators of a plurality demodulators for use in demodulating the precoded first downlink signal.

Clause 12: The method of Clause 11, wherein the different demodulators comprise at least one of: a per-stream recursive demapping (PSRD) demodulator; or a linear minimum mean-squared error (LMMSE) demodulator.

Clause 13: The method of any one of Clauses 1-12, further comprising receiving an updated downlink transmission preference of the UE, wherein: the updated downlink transmission preference of the UE comprises at least one of: an updated demodulation complexity preference of the UE that is different from the demodulation complexity preference of the UE, or an updated downlink channel capacity preference of the UE that is different from the downlink channel capacity preference of the UE.

Clause 14: The method of Clause 13, further comprising: applying a second precoder, selected based on the updated downlink transmission preference of the UE, to a second downlink signal for transmission to the UE; and transmitting the precoded second downlink signal to the UE over the downlink channel using the plurality of transmission streams, wherein the first precoder is different from the second precoder.

Clause 15: The method of any one of Clauses 1-14, further comprising at least one of: transmitting the request to the UE in a media access control-control element (MAC-CE); or receiving the first message from the UE in a MAC-CE.

Clause 16: A method for wireless communication by a user equipment (UE), comprising: receiving, from a network entity, a request for a downlink transmission preference of the UE; transmitting, to the network entity after receiving the request, a first message indicating the downlink transmission preference of the UE, wherein the downlink transmission preference of the UE comprises at least one of a demodulation complexity preference of the UE or a downlink channel capacity preference of the UE; receiving, from the network entity, a first downlink signal transmitted on a downlink channel using a plurality of transmission streams, wherein: the first downlink signal is precoded based on a first precoder, and the first precoder is based on the downlink transmission preference of the UE; and demodulating the first downlink signal using a first demodulator corresponding to the first precoder.

Clause 17: The method of Clause 16, wherein: when the downlink transmission preference of the UE indicates at least one of a first demodulation complexity preference or a first downlink channel capacity preference, the first precoder comprises a singular value decomposition (SVD) combiner precoder; and when the downlink transmission preference of the UE indicates at least one of a second demodulation complexity preference or a second downlink channel capacity preference, the first precoder comprises a conventional SVD precoder.

Clause 18: The method of Clause 17, wherein the SVD combiner precoder is configured to: combine Eigen vectors corresponding to singular values of the downlink channel; and balance a signal to noise ratio (SNR) across all transmission streams of the plurality of transmission streams.

Clause 19: The method of Clause 17, wherein: the first demodulation complexity preference is higher than the second demodulation complexity preference; and the first downlink channel capacity preference is higher than the second downlink channel capacity preference.

Clause 20: The method of Clause 17, wherein: when first precoder comprises the SVD combiner precoder, the first demodulator comprises one of a per-stream recursive demapping (PSRD) demodulator or a linear minimum mean-squared error (LMMSE) demodulator; and when the first precoder comprises the conventional SVD precoder, the first demodulator comprises one of a diagonal matrix inversion demodulator or a conjugate gradients approximation demodulator.

Clause 21: The method of Clause 17, wherein the downlink transmission preference of the UE indicates at least one of the second demodulation complexity preference or the second downlink channel capacity preference when, at least one of: a battery level of the UE is at or below a threshold; or the UE has a low latency limitation.

Clause 22: The method of any one of Clauses 16-21, further comprising transmitting channel state information (CSI) for the downlink channel to the network entity.

Clause 23: The method of Clause 22, wherein the CSI for the downlink channel indicates at least one of a noise level associated with the downlink channel or Eigen values associated with the downlink channel.

Clause 24: The method of Clause 23, wherein the first precoder is further based on at least one of the noise level associated with the downlink channel or the Eigen values associated with the downlink channel.

Clause 25: The method of any one of Clauses 16-24, further comprising receiving, from the network entity, a second message comprising an indication of the first precoder.

Clause 26: The method of Clause 25, wherein: the indication of the first precoder indicates at least one of a demodulation complexity associated with the first precoder or a downlink channel capacity associated with the first precoder; and the method further comprises selecting the first demodulator based on at least one of the demodulation complexity associated with the first precoder or the downlink channel capacity associated with the first precoder.

Clause 27: The method of Clause 25, wherein the indication of the first precoder indicates: the first precoder comprises a singular value decomposition (SVD) combiner precoder; and demodulation losses, in terms of decibels (dB) or bits, for different demodulators of a plurality demodulators for use in demodulating the precoded first downlink signal.

Clause 28: The method of Clause 27, wherein the different demodulators comprise at least one of: a per-stream recursive demapping (PSRD) demodulator; or a linear minimum mean-squared error (LMMSE) demodulator.

Clause 29: The method of Clause 27, further comprising selecting the first demodulator further based on the indicated demodulation losses for the different demodulators of the plurality demodulators.

Clause 30: The method of any one of Clauses 16-29, further comprising transmitting an updated downlink transmission preference of the UE, wherein: the updated downlink transmission preference of the UE comprises at least one of: an updated demodulation complexity preference of the UE that is different from the demodulation complexity preference of the UE, or an updated downlink channel capacity preference of the UE that is different from the downlink channel capacity preference of the UE.

Clause 31: The method of Clause 30, further comprising receiving, from the network entity, a second downlink signal transmitted on the downlink channel using the plurality of transmission streams, wherein: the second downlink signal is precoded based on a second precoder that is different from the first precoder, the second precoder is based on the updated downlink transmission preference of the UE, the method further comprises demodulating the second downlink signal using a second demodulator corresponding to the second precoder, and the second demodulator is different from the first demodulator.

Clause 32: The method of any one of Clauses 16-31, further comprising at least one of: receiving the request from the network entity in a media access control-control element (MAC-CE); or transmitting the first message to the network entity in a MAC-CE.

Clause 33: An apparatus, comprising: at least one memory comprising executable instructions; and at least one processor configured to execute the executable instructions and cause the apparatus to perform a method in accordance with any combination of Clauses 1-32.

Clause 34: An apparatus, comprising means for performing a method in accordance with any combination of Clauses 1-32.

Clause 35: A non-transitory computer-readable medium comprising executable instructions that, when executed by at least one processor of an apparatus, cause the apparatus to perform a method in accordance with any combination of Clauses 1-32.

Clause 36: A computer program product embodied on a computer-readable storage medium comprising code for performing a method in accordance with any combination of Clauses 1-32.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

In some cases, rather than actually transmitting a signal, an apparatus (e.g., a wireless node or device) may have an interface to output the signal for transmission. For example, a processor may output a signal, via a bus interface, to a radio frequency (RF) front end for transmission. Accordingly, a means for outputting may include such an interface as an alternative (or in addition) to a transmitter or transceiver. Similarly, rather than actually receiving a signal, an apparatus (e.g., a wireless node or device) may have an interface to obtain a signal from another device. For example, a processor may obtain (or receive) a signal, via a bus interface, from an RF front end for reception. Accordingly, a means for obtaining may include such an interface as an alternative (or in addition) to a receiver or transceiver.

While the present disclosure may describe certain operations as being performed by one type of wireless node, the same or similar operations may also be performed by another type of wireless node. For example, operations performed by a user equipment (UE) may also (or instead) be performed by a network entity (e.g., a base station or unit of a disaggregated base station). Similarly, operations performed by a network entity may also (or instead) be performed by a UE.

Further, while the present disclosure may describe certain types of communications between different types of wireless nodes (e.g., between a network entity and a UE), the same or similar types of communications may occur between same types of wireless nodes (e.g., between network entities or between UEs, in a peer-to-peer scenario). Further, communications may occur in reverse order than described.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus for wireless communication by a network entity, comprising:
one or more processors individually or collectively configured to execute instructions on one or more memories and to cause the network entity to:
transmit, to a user equipment (UE), a request for a downlink transmission preference of the UE;
receive, from the UE after transmitting the request, a first message indicating the downlink transmission preference of the UE, wherein the downlink transmission preference of the UE comprises at least one of a demodulation complexity preference of the UE or a downlink channel capacity preference of the UE;
apply a first precoder, selected based on the downlink transmission preference of the UE, to a first downlink signal for transmission to the UE; and
transmit the precoded first downlink signal to the UE over a downlink channel using a plurality of transmission streams.

2. The apparatus of claim 1, wherein:
when the downlink transmission preference of the UE indicates at least one of a first demodulation complexity preference or a first downlink channel capacity preference, the first precoder comprises a singular value decomposition (SVD) combiner precoder; and
when the downlink transmission preference of the UE indicates at least one of a second demodulation complexity preference or a second downlink channel capacity preference, the first precoder comprises a conventional SVD precoder.

3. The apparatus of claim 2, wherein the SVD combiner precoder is configured to:
combine Eigen vectors corresponding to singular values of the downlink channel; and
balance a signal to noise ratio (SNR) across all transmission streams of the plurality of transmission streams.

4. The apparatus of claim 2, wherein:
the first demodulation complexity preference is higher than the second demodulation complexity preference; and
the first downlink channel capacity preference is higher than the second downlink channel capacity preference.

5. The apparatus of claim 2, wherein the one or more processors are configured to cause the network entity to select the SVD combiner precoder when:
the downlink transmission preference of the UE indicates at least one of the first demodulation complexity preference or the first downlink channel capacity preference; and
a gain associated with the SVD combiner precoder is a threshold amount higher than a gain associated with the SVD precoder.

6. The apparatus of claim 1, wherein:
the one or more processors are further configured to cause the network entity to receive channel state information (CSI) for the downlink channel from the UE;
the CSI for the downlink channel indicates at least one of a noise level associated with the downlink channel or Eigen values associated with the downlink channel; and
the one or more processors are configured to cause the network entity to select the first precoder further based on at least one of the noise level associated with the downlink channel or the Eigen values associated with the downlink channel.

7. The apparatus of claim 1, wherein the one or more processors are further configured to cause the network entity to transmit, to the UE, configuration information comprising an indication of the first precoder.

8. The apparatus of claim 7, wherein the indication of the first precoder indicates at least one of a demodulation complexity associated with the first precoder or a downlink channel capacity associated with the first precoder.

9. The apparatus of claim 7, wherein the indication of the first precoder indicates:
the first precoder comprises a singular value decomposition (SVD) combiner precoder; and
demodulation losses, in terms of decibels (dB) or bits, for different demodulators of a plurality demodulators for use in demodulating the precoded first downlink signal.

10. The apparatus of claim 9, wherein the different demodulators comprise at least one of:
a per-stream recursive demapping (PSRD) demodulator; or
a linear minimum mean-squared error (LMMSE) demodulator.

11. The apparatus of claim 1, wherein:
the one or more processors are further configured to cause the network entity to receive an updated downlink transmission preference of the UE; and
the updated downlink transmission preference of the UE comprises at least one of:
an updated demodulation complexity preference of the UE that is different from the demodulation complexity preference of the UE; or
an updated downlink channel capacity preference of the UE that is different from the downlink channel capacity preference of the UE.

12. The apparatus of claim 11, wherein the one or more processors are further configured to cause the network entity to:
apply a second precoder, selected based on the updated downlink transmission preference of the UE, to a second downlink signal for transmission to the UE; and
transmit the precoded second downlink signal to the UE over the downlink channel using the plurality of transmission streams, wherein the first precoder is different from the second precoder.

13. The apparatus of claim 1, wherein at least one of:
the one or more processors are configured to cause the network entity to transmit the request to the UE in a media access control-control element (MAC-CE); or
the one or more processors are configured to cause the network entity to receive the first message from the UE in a MAC-CE.

14. An apparatus for wireless communication by a user equipment (UE), comprising:
one or more processors individually or collectively configured to execute instructions on one or more memories and to cause the UE to:
receive, from a network entity, a request for a downlink transmission preference of the UE;
transmit, to the network entity after receiving the request, a first message indicating the downlink transmission preference of the UE, wherein the downlink transmission preference of the UE comprises at least one of a demodulation complexity preference of the UE or a downlink channel capacity preference of the UE;
receive, from the network entity, a first downlink signal transmitted on a downlink channel using a plurality of transmission streams, wherein:
the first downlink signal is precoded based on a first precoder; and
the first precoder is based on the downlink transmission preference of the UE; and
demodulate the first downlink signal using a first demodulator corresponding to the first precoder.

15. The apparatus of claim 14, wherein:
when the downlink transmission preference of the UE indicates at least one of a first demodulation complexity preference or a first downlink channel capacity preference, the first precoder comprises a singular value decomposition (SVD) combiner precoder; and
when the downlink transmission preference of the UE indicates at least one of a second demodulation complexity preference or a second downlink channel capacity preference, the first precoder comprises a conventional SVD precoder.

16. The apparatus of claim 15, wherein the SVD combiner precoder is configured to:
combine Eigen vectors corresponding to singular values of the downlink channel; and
balance a signal to noise ratio (SNR) across all transmission streams of the plurality of transmission streams.

17. The apparatus of claim 15, wherein:
the first demodulation complexity preference is higher than the second demodulation complexity preference; and
the first downlink channel capacity preference is higher than the second downlink channel capacity preference.

18. The apparatus of claim 15, wherein:
when first precoder comprises the SVD combiner precoder, the first demodulator comprises one of a per-stream recursive demapping (PSRD) demodulator or a linear minimum mean-squared error (LMMSE) demodulator; and
when the first precoder comprises the conventional SVD precoder, the first demodulator comprises one of a diagonal matrix inversion demodulator or a conjugate gradients approximation demodulator.

19. The apparatus of claim 15, wherein the downlink transmission preference of the UE indicates at least one of the second demodulation complexity preference or the second downlink channel capacity preference when, at least one of:
a battery level of the UE is at or below a threshold; or
the UE has a low latency limitation.

20. The apparatus of claim 14, wherein:
the one or more processors are further configured to cause the UE to transmit channel state information (CSI) for the downlink channel to the network entity;
the CSI for the downlink channel indicates at least one of a noise level associated with the downlink channel or Eigen values associated with the downlink channel; and
the first precoder is further based on at least one of the noise level associated with the downlink channel or the Eigen values associated with the downlink channel.

21. The apparatus of claim 14, wherein the one or more processors are further configured to cause the UE to receive, from the network entity, a second message comprising an indication of the first precoder.

22. The apparatus of claim 21, wherein:
the indication of the first precoder indicates at least one of a demodulation complexity associated with the first precoder or a downlink channel capacity associated with the first precoder; and
the one or more processors are further configured to cause the UE to select the first demodulator based on at least one of the demodulation complexity associated with the first precoder or the downlink channel capacity associated with the first precoder.

23. The apparatus of claim 21, wherein the indication of the first precoder indicates:
the first precoder comprises a singular value decomposition (SVD) combiner precoder; and
demodulation losses, in terms of decibels (dB) or bits, for different demodulators of a plurality demodulators for use in demodulating the precoded first downlink signal.

24. The apparatus of claim 23, wherein the different demodulators comprise at least one of:
a per-stream recursive demapping (PSRD) demodulator; or
a linear minimum mean-squared error (LMMSE) demodulator.

25. The apparatus of claim 23, wherein the one or more processors are configured to cause the UE to select the first demodulator further based on the indicated demodulation losses for the different demodulators of the plurality demodulators.

26. The apparatus of claim 14, wherein:
the one or more processors are further configured to cause the UE to transmit an updated downlink transmission preference of the UE; and
the updated downlink transmission preference of the UE comprises at least one of:
an updated demodulation complexity preference of the UE that is different from the demodulation complexity preference of the UE; or
an updated downlink channel capacity preference of the UE that is different from the downlink channel capacity preference of the UE.

27. The apparatus of claim 26, wherein:
the one or more processors are further configured to cause the UE to receive, from the network entity, a second downlink signal transmitted on the downlink channel using the plurality of transmission streams;
the second downlink signal is precoded based on a second precoder that is different from the first precoder;
the second precoder is based on the updated downlink transmission preference of the UE;
the one or more processors are further configured to cause the UE to demodulate the second downlink signal using a second demodulator corresponding to the second precoder; and
the second demodulator is different from the first demodulator.

28. The apparatus of claim 14, wherein at least one of:
the one or more processors are configured to cause the UE to receive the request from the network entity in a media access control-control element (MAC-CE); or
the one or more processors are configured to cause the UE to transmit the first message to the network entity in a MAC-CE.

29. A method for wireless communication by a network entity, comprising:
transmitting, to a user equipment (UE), a request for a downlink transmission preference of the UE;
receiving, from the UE after transmitting the request, a first message indicating the downlink transmission preference of the UE, wherein the downlink transmission preference of the UE comprises at least one of a demodulation complexity preference of the UE or a downlink channel capacity preference of the UE;
applying a first precoder, selected based on the downlink transmission preference of the UE, to a first downlink signal for transmission to the UE; and
transmitting the precoded first downlink signal to the UE over a downlink channel using a plurality of transmission streams.

30. A method for wireless communication by a user equipment (UE), comprising:
receiving, from a network entity, a request for a downlink transmission preference of the UE;
transmitting, to the network entity after receiving the request, a first message indicating the downlink transmission preference of the UE, wherein the downlink transmission preference of the UE comprises at least one of a demodulation complexity preference of the UE or a downlink channel capacity preference of the UE;
receiving, from the network entity, a first downlink signal transmitted on a downlink channel using a plurality of transmission streams, wherein:
the first downlink signal is precoded based on a first precoder, and
the first precoder is based on the downlink transmission preference of the UE; and
demodulating the first downlink signal using a first demodulator corresponding to the first precoder.
